(19) United States
(12) Patent Application Publication
(10) Pub. No.: US 2011/0150724 A1
(43) Pub. Date: Jun. 23, 2011

(54) Device for Gripping a Reaction Cuvette

(76) Inventors: Thomas Fürle, Herblay (FR); Philippe Croisard, Acheres (FR)

(21) Appl. No.: 12/996,111

(22) PCT Filed: May 26, 2009
(86) PCT No.: PCT/FR09/00603

§ 371 Date: Feb. 18, 2011

(30) Foreign Application Priority Data
Jun. 9, 2008 (FR) 08/03196

(51) Int. Cl. B01L 9/06; B01L 3/14

(52) U.S. Cl. 422/549; 422/562

(57) ABSTRACT

A device for gripping a reaction cuvette, in particular in an automatic appliance for analyzing chemical or biological samples, the device comprising a gripper head (16) formed by a channel-section member (18) having its side flanges (20) extended by elastically-deformable tabs (22) for resiliently clamping on a reaction cuvette.

The invention relates to a device for gripping a reaction cuvette, in particular in an automatic appliance for analyzing chemical or biological samples.

Documents EP-A-0 325 874 and WO-A-03/065047 describe reaction cuvettes used for determining the times taken for the physical state of a medium to be modified, in particular for determining the time taken by a blood sample to coagulate, those cuvettes being open at their top ends and including bottoms that are curved to form a running track for a ball of ferromagnetic material that can be moved in the cuvette with periodic motion by means of an external magnetic field, with variations in the amplitude and/or the frequency of the motion of the ball being representative of the physical state of the blood sample.

The appliances in which those cuvettes are used include gripper devices for taking hold of the cuvettes and moving them to various points, e.g. to put them in an incubator and then in a measurement zone and finally in a container for storing them prior to destruction. Present gripper devices are of the pneumatic suction type, each having two suction cups that need to be placed on studs at the top of a cuvette.

When the suction cups are connected to pneumatic suction, the cuvette is held firmly by the gripper device and can be transported reliably from one point to another within the appliance.

Nevertheless, it is necessary for the suction cups to be positioned accurately on the studs of the cuvette, and that does not always happen, since no means are provided for ensuring accurate positioning of the gripper device on the cuvette.

The use of suction cups, which run the risk of wearing out more or less quickly, together with pneumatic suction also complicates such gripper devices and reduces their reliability and lifetime.

A particular object of the invention is to provide a solution to those problems that is simple, effective, and inexpensive.

To this end, the invention provides a gripper device for gripping a reaction cuvette, in particular in an automatic appliance for analyzing chemical or biological samples and including means for applying a gripper head to the top end of a cuvette, and means for securing said head to the cuvette, the device being characterized in that the gripper head has elastically-deformable tabs for engaging the top end edges of the cuvette when the head is pressed against the cuvette and for holding the cuvette by resilient clamping, and positioning and centering means for positioning and centering the gripper head on the top end of the cuvette, these means advantageously being of the type involving co-operating shapes.

The device of the invention is thus essentially mechanical and no longer requires any connection to pneumatic suction means or the use of suction cups, such that the drawbacks associated with those means of the prior art are eliminated.

In a preferred embodiment of the invention, the gripper head comprises a channel-section member for covering the top end of the cuvette and having side flanges from which the above-mentioned elastically-deformable tabs depend.

The positioning and centering means may be formed on the side flanges of the channel-section member and may comprise projecting elements for co-operating with complementary cavities or notches in the top edges of the cuvette.

Advantageously, the elastically-deformable tabs of the gripper head have chamfered bottom ends for sliding over the top edges of the cuvette when the gripper head is applied to the cuvette.

These chamfered ends serve both to center the gripper head in a transverse direction on the cuvette and to clamp resiliently to the top end of the cuvette between the elastically-deformable tabs of the gripper head.

Furthermore, the chamfered ends of the tabs form snap-fastening hooks for engaging side rims on the top end of the cuvette or tips for bearing against the side walls of the cuvette.

According to another characteristic of the invention, the device includes means for separating the the gripper head from the cuvette that consist of a pusher that is movable by control means between a high, inactive position in which the pusher is inside the gripper head, and a low, active position in which it presses against the top end of a cuvette and disengages it from the gripper head.

In the above embodiment of the invention, the pusher in its high, inactive position is housed inside the channel-section member.

Advantageously, the means for controlling the pusher are electromagnetic, the pusher being connected for example to the movable core of an electromagnet, or else they are pneumatic.

According to yet another characteristic of the invention, the gripper head includes detector means for detecting a cuvette.

These means serve to confirm that a cuvette has indeed been gripped by the gripper device.

In a particularly simple embodiment, the detector means comprise a finger guided to move in translation through an orifice in the gripper head between a low position corresponding to the absence of a cuvette in the gripper head, and a high position into which it is pushed by a cuvette held by the gripper head.

The movable finger may be associated with a switch that changes its electrical conduction state when the finger is moved from one of its positions to the other.

The invention also provides a reaction cuvette for use in an automatic analysis appliance fitted with a gripper device of the above-described type, the cuvette being characterized in that its top end includes projecting elements and/or cutouts or notches for positioning and centering purposes that are formed in or on the top edges of its side walls or in or on rims projecting from its side walls.

The invention can be better understood and other characteristics, details, and advantages thereof appear more clearly on reading the following description made by way of example with reference to the accompanying drawings, in which:

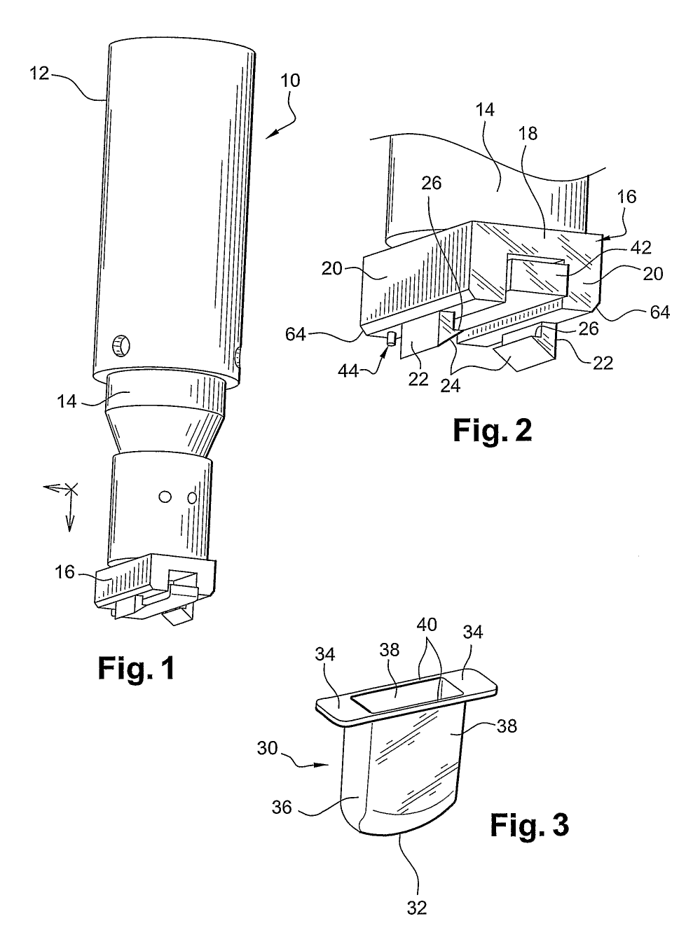

FIG. 1 is a diagrammatic perspective view of a gripper device of the invention;

FIG. 2 is a fragmentary view on a larger scale of the head of the device;

FIG. 3 is a diagram of a reaction cuvette suitable for use with the gripper head of FIGS. 1 and 2;

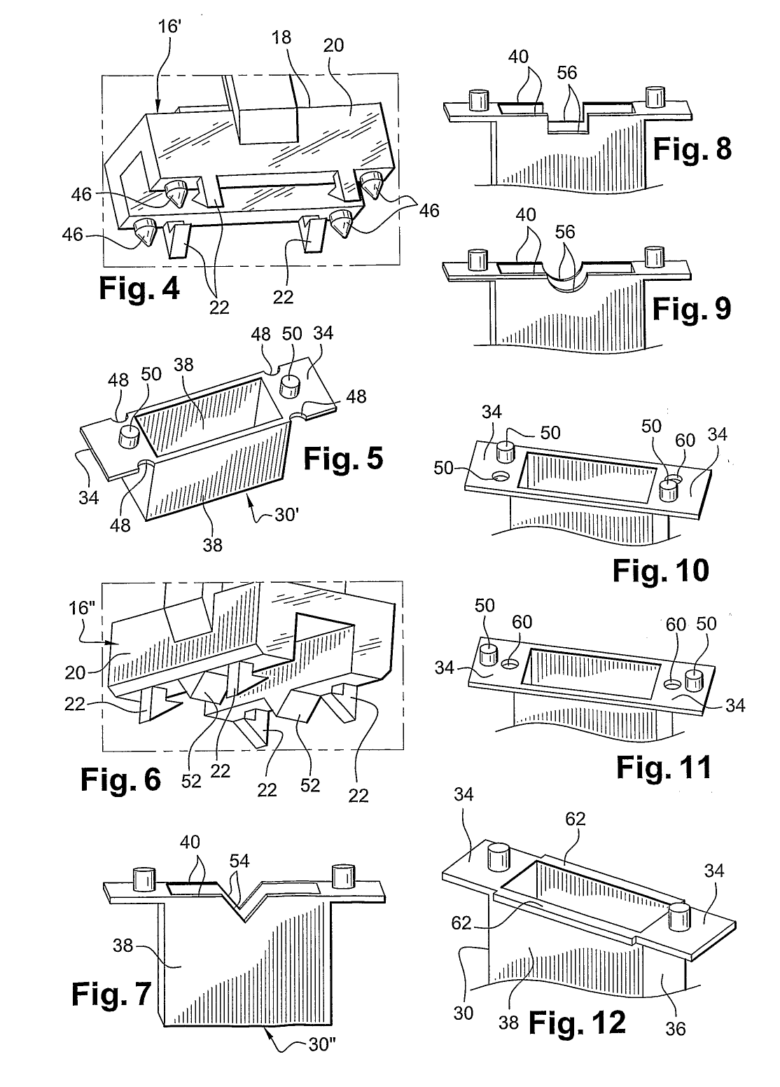

FIGS. 4 and 5 show a variant embodiment of the gripper head and the corresponding cuvette;

FIGS. 6 and 7 show another variant embodiment of a gripper head and the corresponding reaction cuvette; and

FIGS. 8 to 12 show further variant embodiments of reaction cuvettes.

FIG. 1 is a diagram showing a gripper device 10 for gripping a reaction cuvette in an automatic analysis appliance of the above-described type, the device comprising a body 12 having an element 14 mounted therein to carry a gripper head 16 for gripping a cuvette at its bottom end, the element 14 and the head 16 being movable by fluid pressure or by an electric motor.

The gripper head 16, which can be seen better in FIG. 2, comprises a channel-section member 18 of downwardly-open section, with two vertical slide flanges 20, each including a tab 22 extending downwards from the bottom end of the corresponding side flange 20. These tabs 22 have chamfered bottom ends 24, the two chamfered faces of these tabs facing each other and flaring apart from each other going downwards, their top ends being connected via respective horizontal plane faces 26 to the corresponding tabs 22, thereby forming tips or hooks of triangular section.

The gripper head may be used on reaction cuvettes having a variety of shapes, one of which is shown by way of example in FIG. 3. This cuvette 30 is of known type and is generally in the form of a rectangular parallelepiped, with its bottom end being closed by a rounded bottom wall 32, and its top end being opened and lying between two side rims 34 connected to its small side faces 36.

When the device 10 is used to grip the cuvette 30, the gripper head 16 is positioned above the cuvette 30 so that the side flanges 20 of the section member 18 are in alignment with the large side walls 38 of the cuvette. When the head 16 is lowered vertically onto the cuvette 30, the chamfered faces 24 of the tabs 22 bear against the top edges 40 of the large side faces 38 of the cuvette and slide on said edges, the tabs 22 moving outwards a little apart from each other until the bottom faces of the side flanges 20 of the section member 18 comes to bear against the top edges 40 of the cuvette. The cuvette is then clamped between the top horizontal edges of the chamfered faces 24 of the tabs 22 of the gripper head, and the cuvette 30 may be moved without risk from one point to another of the analysis appliance.

The gripper head 16 also has cuvette release means that are constituted in this example by a pusher 42 mounted in the gripper head 16 between the side flanges 20 of the channel-section member 18. The pusher 42 may be in the form of a rectangular block that is connected to the moving core of an electromagnet housed inside the element 14 of the gripper device.

When the pusher 42 is in a high position, as shown in FIG. 2, it is spaced apart a little from the top end of a cuvette 30 held by the gripper head 16. Exciting the electromagnet causes the pusher 42 to move downwards so as to press against the top end of the cuvette 30, i.e. against the top edges 40 and the side rims 34 so as to push the cuvette downwards until it escapes from the tabs 22 of the gripper head.

When the electromagnet ceases to be excited, the pusher 42 is returned to its high position by a return spring.

In a variant, the pusher 42 is controlled pneumatically. The control also includes safety means to prevent the cuvette being ejected from the gripper head in the event of an electrical or other breakdown, which would run the risk of contaminating the analysis appliance.

The device of the invention may also be fitted with a sensor to detect the presence of a cuvette 30 between the side tabs 22 of the gripper head. By way of example, and as shown diagrammatically in FIG. 2, the sensor may comprise a movable finger 44 that is guided in an orifice of the bottom horizontal face of a flange 20 and that is associated with a switch and a return spring housed inside the channel-section member 18 so that when a cuvette 30 is held by the gripper head 10, a portion of the top end of the cuvette, e.g. one of the side rims 34, presses against the finger 44 and pushes it into the inside of the section member 18, thereby changing the electrical conduction state of the switch associated with the movable finger 44.

When the cuvette 30 is released by the gripper head, the return spring pushes the finger 44 downwards into its position projecting from the bottom face of the side flange 20 of the section member 18.

When the gripper head 16 of FIG. 2 is used for gripping a cuvette 30 of the kind shown in FIG. 3, the cuvette is automatically centered on the gripper head in a transverse direction perpendicular to its large side faces 38, by virtue of being gripped between the two elastically-deformable tabs 22.

The gripper head may also be provided with means for centering the cuvette in a longitudinal direction, as shown for example in FIGS. 4 and 6.

The gripper head 16′ of FIG. 4 comprises a channel-section member 18 having its side flanges 20 extended downwards, each by two elastically-deformable side tabs 22 and by two frustoconical studs 46 located in the vicinity of the longitudinal ends of the walls 20. These frustoconical studs 46 are designed to engage in semicircular notches or cutouts 48 in the side rims 34 of the cuvette 30′ shown in FIG. 5. The frustoconical studs 46 and the notches 48 thus serve to center the cuvette 30′ in the gripper head 16′ in a longitudinal direction parallel to the large faces 38 of the cuvette, and also in a transverse direction perpendicular to said large faces.

FIG. 5 shows that the side rims 34 of the cuvette also include respective projecting studs 50, which studs 50 act in known manner to fasten the cuvette 30 to an elongate strip of plastics material so as to form a chain of cuvettes that are connected to one another by the strip of plastics material, this arrangement enabling the analysis appliance to be fed from a reel containing a long rolled-up strip carrying a very large number of cuvettes 30.

The gripper head 16″ of FIG. 6 also comprises a channel-section member 18 with its side flanges 20, each extended downwards by two elastically-deformable tabs 22 and by a projecting element 52 of triangular section with its vertex pointing downwards, this element 52 being situated between the two side tabs 22 of the side flange 20 and serving to engage in a triangular notch 54 in the corresponding top edge 40 of a large side face 38 of the cuvette 30″ of FIG. 7.

These triangular elements 52 serve to position the cuvette 30″ longitudinally relative to the gripper head 16″. The transverse positioning of the cuvette relative to the gripper head is provided by the elastically-deformable tabs 22 whose hooks bear against the large side walls 38 of the cuvette.

In the variant embodiments of FIGS. 8 and 9, the notches 56 in the top edges 40 of the cuvette are respectively rectangular in shape or circularly arcuate in shape. The projecting elements 52 on the section member of the gripper head are naturally then of a corresponding rectangular or circularly arcuate shape.

In the variant embodiment of FIG. 10, each of the side rims 34 of the cuvette 30 has a cylindrical stud 50 and a circular hole 60 that are in transverse alignment. Furthermore, from one side rim 34 to the other, the two cylindrical studs 50 are in alignment on a diagonal and the two circular holes 60 are likewise in alignment on a diagonal.

Under such circumstances, the longitudinal ends of the flanges 20 of the channel-section member of the gripper head respectively include a cylindrical orifice for receiving a stud 50 of the cuvette or a frustoconical finger for engaging in a circular hole 60 of a rim 34 of the cuvette.

In the variant of FIG. 11, each side rim 34 of the cuvette has a cylindrical stud 50 and a circular hole 60 that are in alignment in the longitudinal direction and that are designed to co-operate with corresponding cylindrical orifices and frustoconical fingers at the longitudinal ends of the gripper head.

Another variant embodiment of a cuvette 30 is shown in FIG. 12, the cuvette including, in addition to the two rims 34 projecting from its small faces 36, two side rims 62 projecting from its large side faces 38, these two side rims 62 presenting a width or transverse dimension that is small.

The two side rims 62 co-operate with the elastically-deformable tabs 22 of the gripper head by snap-fastening, with the hooks of the tabs 22 engaging under the side rims 62 when the gripper head is lowered onto the cuvette 30.

In order to release the cuvette 30 from the gripper head, as in the above-described embodiments, it suffices to cause the pusher 42 to move downwards and press against the side rims 62 of the cuvette so as to push it out from the elastically-deformable tabs 22 of the gripper head.

It should be observed that because they have four elastically-deformable tabs 22, the gripper heads of FIGS. 4 and 6 are still capable of operating correctly in the event of one of the tabs breaking.

Furthermore, it is advantageous for the bottom ends of the flanges 20 of the section member 18 of the gripper head to be chamfered or convex on their outside faces, as shown at 64 in FIGS. 2 and 6, since that enables the gripper head itself to be positioned and centered on certain elements of an analysis appliance, such as for example a cuvette transporter shuttle or an incubation or measurement plate.

The convex curved or chamfered ends 64 of the flanges 20 of the section member serve to accommodate dimensional dispersions and tolerances when accurately positioning the gripper head on a shuttle or an incubation and measurement plate, in order to take hold of or put down a cuvette.

Tests have shown that the strokes of the tips over the side walls 38 of a cuvette need to be at least 0.3 millimeters (mm) to 0.5 mm and preferably in the range 1.5 mm to 2 mm in order to grip the cuvette well.

The gripper head of the invention has been subjected to reliability and robustness testing that has given the following results:
no operating defect after taking hold of cuvettes more than 50,000 times;
a lifetime for taking hold of cuvettes at least 500,000 times.

1. A gripper device for gripping a reaction cuvette, in particular in an automatic appliance for analyzing chemical or biological samples and including means for applying a gripper head to the top end of a cuvette, and means for securing said head to the cuvette, the device being characterized in that the gripper head has elastically-deformable tabs for engaging the top end edges of the cuvette when the head is pressed against the cuvette and for holding the cuvette by resilient clamping, and positioning and centering means for positioning and centering the gripper head on the top end of the cuvette.

2. A device according to claim 1, characterized in that the positioning and centering means are of the type involving co-operating shapes.

3. A device according to claim 1, characterized in that the gripper head comprises a channel-section member (18) for covering the top end of the cuvette and having side flanges from which the above-mentioned elastically-deformable tabs depend.

4. A device according to claim 1, characterized in that the positioning and centering means are formed on the side flanges of the channel-section member and comprise projecting elements for co-operating with complementary cavities or notches in the top edges of the cuvette.

5. A device according to claim 1, characterized in that the elastically-deformable tabs of the gripper head have chamfered bottom ends for sliding over the top edges of the cuvette when the gripper head is applied to the cuvette.

6. A device according to claim 5, characterized in that the chamfered ends of the tabs form snap-fastening hooks for engaging side rims on the top end of the cuvette or tips for bearing against the side walls of the cuvette.

7. A device according to claim 1, characterized in that the gripper head includes a pusher movable by control means between a high, inactive position in which the pusher is inside the gripper head, and a low, active position in which it presses against the top end of a cuvette and disengages it from the gripper head.

8. A device according to claim 3, wherein the gripper head includes a pusher movable by control means between a high, inactive position in which the pusher is inside the gripper head, and a low, active position in which it presses against the top end of a cuvette and disengages it from the gripper head and wherein the pusher in its high, inactive position is housed inside the channel-section member.

9. A device according to claim 8, characterized in that the pusher control means are electromagnetic or pneumatic.

10. A device according to claim 1, characterized in that the gripper head includes detector means for detecting a cuvette.

11. A device according to claim 9, characterized in that the detector means comprise a finger guided to move in translation through an orifice in the gripper head between a low position corresponding to the absence of a cuvette in the gripper head, and a high position into which it is pushed by a cuvette held by the gripper head.

12. A device according to claim 11, characterized in that the movable finger is associated with a switch that changes its electrical conduction state when the finger is moved from one of its positions to the other.

13. A device according to claim 3, characterized in that the bottom ends of the walls of the section member have convex curves or chamfers.

14. A reaction cuvette for use in an automatic analysis appliance fitted with a gripper device according to any preceding claim, the cuvette being characterized in that its top end includes projecting elements and/or cutouts or notches for positioning and centering purposes that are formed in or on the top edges of its side walls or in or on rims projecting from its side walls.
